(19) United States
(12) Patent Application Publication
(10) Pub. No.: US 2004/0072601 A1
(43) Pub. Date: Apr. 15, 2004

(54) Portable motorcycle burnout platform

(76) Inventor: Jeffrey Paul Burton, Walhalla, SC (US)

Correspondence Address: LEIGH P. GREGORY, ATTORNEY AT LAW, PO BOX 168, CLEMSON, SC, 29633-0168, US

(21) Appl. No.: 10/256,294

(22) Filed: Sep. 27, 2002

(51) Int. Cl. A63F 13/00

(52) U.S. Cl. 463/7; 108/55.1

(57) ABSTRACT

A portable display platform for safely performing a motorcycle burnout stunt is disclosed, which includes a textured surface section of the platform floor for frictionally degrading the motorcycle's rear drive wheel tire and means for securing the motorcycle's front wheel tire, among other safety features. In addition to decreasing the risk to spectators, nearby property, and to the motorcyclist performing the burnout stunt, the present portable display platform preferably includes ornamental indicia and lighting to enhance entertainment aspect of the stunt performance.

### FIELD OF THE INVENTION

The present invention is directed to a display platform for safely performing a motorcycle stunt known as a “burnout.”

### BACKGROUND OF THE INVENTION

As the number of motorcycle enthusiasts increases, many nightclubs and other venues are sponsoring promotional events designed to attract bikers. Such rallies or “bike nights” provide the motorcyclists with an opportunity to display and admire each other's bikes and display their abilities to control and maneuver their bikes by performing stunts.

One particularly popular stunt is the “burnout.” Basically, a burnout consists of engaging the rear drive wheel and the front wheel brake at the same time. With the brake engaged, the rear tire spins, heats up, eventually degrades, and, if the stunt is continued, eventually bursts.

Burnouts are a well-known aspect of a variety of types of racing. For both motorcycle and automobile racing, burnouts are performed in order to heat the drive wheel tires and soften the rubber of the tires for improved frictional engagement of the racing surface. They add to the anticipation and drama of the race and have become a part of American popular culture.

In a motorcycle burnout, although the brake prevents a complete forward motion of the bike, the spinning rear tire causes the rear of the bike to pivot in an arc about the front wheel, the extent of which is contained only by the ability of the biker performing the stunt. Of course, the inherent dangers are obvious. If the brake is inadvertently released, the motorcyclist performing the stunt loses control of his bike, endangering nearby on-lookers and vehicles or other property, not to mention the biker himself.

In order to limit the risks to spectators and property, many venues which are frequented by motorcyclists have constructed burnout pits, i.e., designated areas for performing burnouts and other stunts, typically cement in construction, which are separate from the parking lot and are in some way fenced or cordoned off in order to contain an out-of-control bike. Although burnout pits greatly reduce the risk of harm to nearby people or property as compared to the more common performance of burnouts in a parking lot or driveway of an establishment, there remains room in the art for improvement.

For one thing, the risk to the motorcyclist performing the stunt is only marginally reduced when the stunt is performed in a burnout pit. That is, although the motorcyclist is less likely to impact a spectator or vehicle while performing a burnout in a burnout pit, if he loses control of his bike he will, himself, impact the side wall or fence.

Also, a burnout pit is not transportable. Each establishment that wishes to provide an area for the safe performance of burnouts must bear the expense of constructing a burnout pit and must concomitantly lose square footage that would otherwise be put to some other use, typically parking.

### SUMMARY OF THE INVENTION

Accordingly, the present invention is directed to a portable display platform for safely performing a motorcycle burnout stunt wherein the tire of the rear drive wheel is frictionally degraded, optionally to the point of bursting, the display platform consisting of a platform body which includes a forward portion, a rear portion, and a platform floor surface, a rough surface section defined within the platform floor surface, the rough surface section being made of a material which has a roughness capable of frictionally degrading the rear drive wheel tire, means for securing the front wheel tire of the motorcycle defined at the forward portion of the platform body, which is capable of securing the motorcycle during the performance of the burnout stunt when the rear tire is frictionally degraded essentially to the point of bursting, means for transporting the platform body, and means for stabilizing the platform body during the performance of the burnout stunt, wherein the display platform weighs less than about 10,000 pounds.

Other principle advantages of the invention would become apparent to those skilled in the art upon review of the following drawings, the detailed description and the attached claims.

### BRIEF DESCRIPTION OF THE FIGURES OF THE DRAWING

A better understanding of the present invention can be obtained when the following detailed description of the preferred embodiment is considered in conjunction with the following drawings, in which,

FIG. 1 is perspective view of the present inventive portable burnout platform during use;

FIG. 2 is a plan view of the burnout platform of the present invention;

FIG. 3A is a side view of the burnout platform of the present invention with the ramp extended;

FIG. 3B is a side view of the burnout platform of the present invention with the stabilizing jacks engaged;

FIG. 4 is a cross-sectional view of the floor of the present inventive burnout platform showing the reinforcing members present within the underlying pan of the textured surface section of the floor;

FIG. 4A is a cross-sectional view illustrating the relative positioning of the underlying pan of the textured surface section of the floor with respect to the remainder of the floor of the present inventive burnout platform; and

FIG. 4B is a cross-sectional view of the floor of the present inventive burnout platform showing the reinforcing members present within the underlying pan of the textured surface section of the floor and illustrating a preferred embodiment in which the upper surface of the rough surface section of the floor is moderately concave in configuration.

### DETAILED DESCRIPTION OF THE PREFERRED EMBODIMENTS

The present invention is directed to a portable display platform for the display of a motorcycle stunt. The present display platform significantly reduces the risk of injury to spectators and nearby property and also reduces the risk of injury to the motorcyclist performing the stunt.

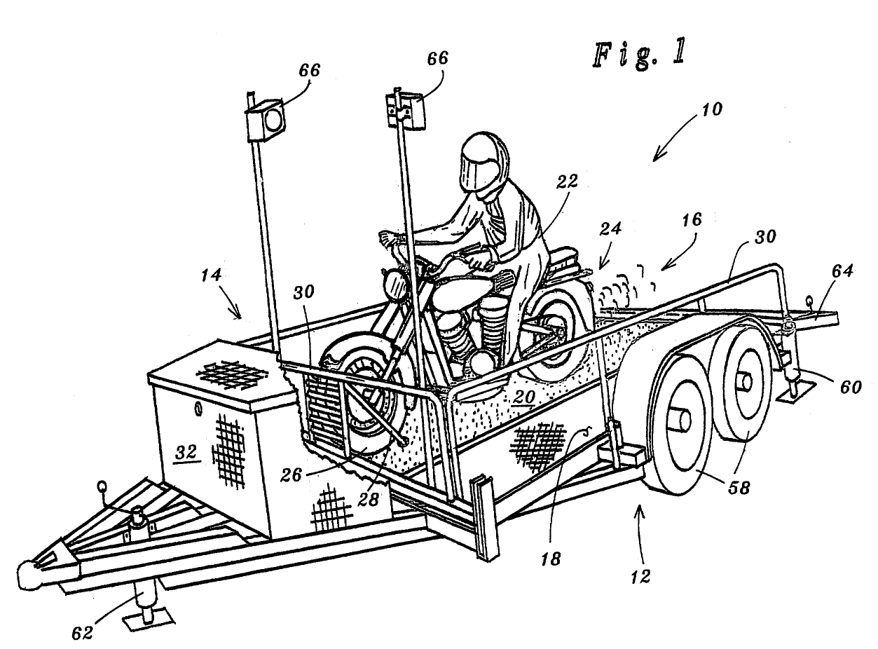

Looking to the figures of the drawing, FIG. 1 is a perspective view of the present portable display platform 10 during use. The platform body 12 includes a forward portion 14, a rear portion 16 and a platform floor surface 18. Defined within the platform floor surface 18 is a textured surface section 20. The textured surface section is preferably concrete or asphalt, although a variety of materials may be provided with a surface of the appropriate texture. Basically, the textured surface section is formed of a material having a roughness on the order of that of paved asphalt, such that it is capable of frictionally degrading the rear drive wheel tire of a motorcycle. However, a surface that is too rough will wear the tire down too quickly and is not preferred.

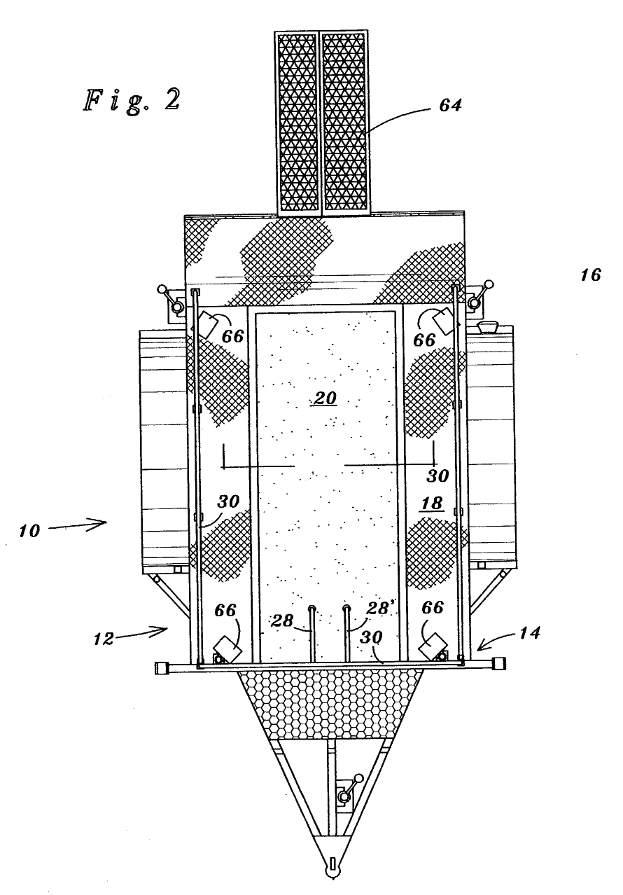

Looking at the plan view of FIG. 2 as well as the perspective view of FIG. 1, the textured surface section 20 is defined within the platform floor surface 18 and is sufficiently large to accommodate the entire length of motorcycle 24. As shown in FIG. 2, the textured surface section is preferably essentially rectangular in shape and about three feet in width by about eight feet in length, although other dimensions and shapes are within the scope of the present invention.

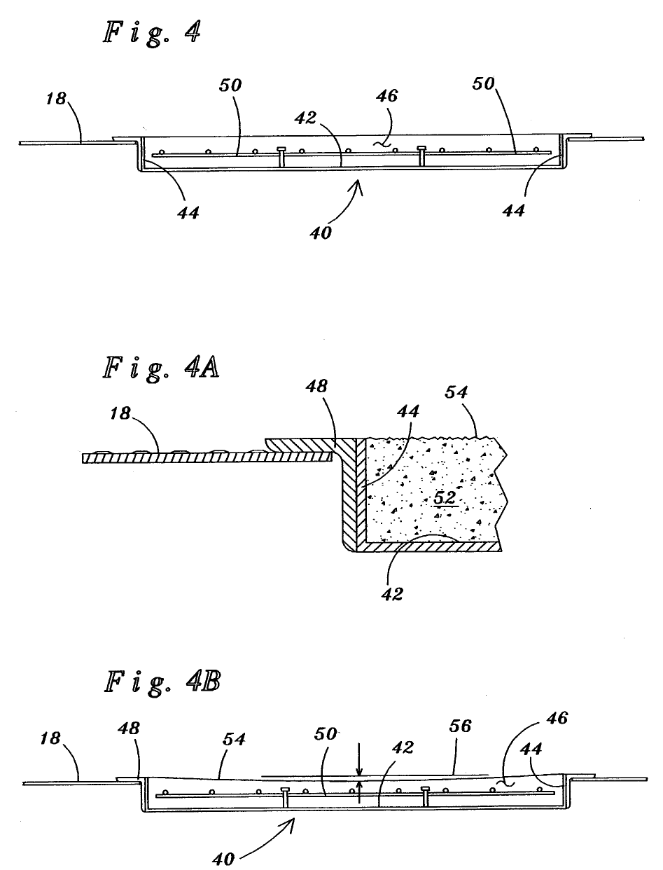

FIGS. 4, 4A, and 4B show the preferred means by which the textured surface section is formed in the platform floor surface. A pan 40 having a floor 42 and sidewalls 44 defining a cavity 46 with an upper flange 48 defined about the upper perimeter is set into an opening in the platform floor surface 18 and held in place by flange 48. Reinforcing members 50 preferably are positioned within cavity or affixed to the floor or sidewalls or both. The surface material 52 is poured in a precursor state into the cavity and allowed to set such that the upper surface 54 of the textured surface section is essentially flush with the platform floor surface 18. In one preferred embodiment, illustrated in FIG. 4B, the upper surface of the textured surface material is shaped to dip downward slightly in the center from the upper surface of the sidewalls and with respect to the level of the platform floor surface 18. That is, line 56 of FIG. 4B represents a level, horizontal plane between the upper surfaces of the sidewalls in order to demonstrate the slight concavity of upper surface 54′. This concavity is provided in order to keep the rear drive wheel of the motorcycle predominately on the textured surface section of the platform floor during performance of the burnout stunt, as is discussed in greater detail below.

Although the reinforcing members, discussed above, aid in preventing cracks, if the textured surface material is concrete it is preferred that the pan is sufficiently deep to allow an at least two inch thick slab of concrete, preferably an at least three inch slab of concrete, to be poured in order to prevent cracking over time and with abuse. Additionally, other factors must be considered in choosing the size and shape of a concrete textured surface section, or any textured surface section, in accordance with the present invention. As noted above, the textured surface section must accommodate the motorcycle and at least some degree of lateral movement of the motorcycle. However, it is an important aspect of the present invention that the portable display platform is readily portable and may be towed with a passenger vehicle, such as a passenger truck or a sport utility vehicle. Thus, the size of the textured surface section, if it is formed of a heavy material such as rock, concrete or asphalt, is limited. That is, it is preferred that the present portable display platform weighs less than about 10,000 pounds, most preferably less than about 6,000 pounds.

As is shown in FIG. 1, during performance of the stunt the motorcyclist 22 disposes his motorcycle 24 on the textured surface section of the platform floor. The front wheel tire 26 is secured by parallel bars 28 and 28′, which are most clearly seen by viewing both the perspective view of FIG. 1 and the plan view of FIG. 2. Such parallel bars are the preferred means for securing the front wheel tire of the motorcycle in accordance with the present invention, although other means may be employed.

Preferably, the parallel bars extend upwardly from the platform floor and are secured, preferably welded, to forward handrail 30. In the absence of a forward handrail, the upper portions of the parallel bars may be secured to a forward wall or to a facing surface of storage box 32. Although other configurations for the parallel bars may be employed, preferably the bars are straight and form an acute angle extending upwardly from the textured surface section of the platform floor toward the forward portion of the platform body.

Further, the parallel bars are spaced such that they accommodate a variety of tire widths and limit, but do not completely preclude, lateral movement of the front wheel tire. It is not necessary to provide a means for retaining the front tire within the parallel bars since the forward momentum of the motorcycle achieves this result, but such means may be employed in accordance with the present invention if desired. In order to prevent inadvertent withdrawal of the front tire from the parallel bars, it is preferred that the bars, when viewed from the side, form the hypotenuse of a triangle sufficiently large to accommodate at least one-fourth to one-third of the front wheel tire when the motorcycle is properly positioned for performance of the stunt.

Other, less preferred, means for securing the front wheel tire include a crevice defined in the platform floor for receiving the tire, or a lockable chain, cable or bracket extending from the floor or some other aspect of the forward portion of the platform, among other optional securing means.

It should be noted that a simple retaining wall, which serves only to preclude forward motion of the motorcycle, is not an adequate means for securing the front wheel tire. The present means for securing the front tire must be capable of securing the motorcycle during the performance of the burnout stunt when the rear tire is being frictionally degraded, even to the point of bursting. Thus, the present means for securing the front wheel tire must at least partially limit the lateral motion of the forward portion of the motorcycle in order to decrease the risk of the rider losing control of the motorcycle.

Yet another safety feature of the present inventive portable display platform is the handrail 30, which preferably extends about a major portion of the periphery of the platform floor. The handrail is preferably close to the floor, much lower than a handrail designed for use by a standing adult. Most preferably the handrail is only about 18 inches above the level of the platform floor. Thus, if the motorcyclist begins to lose control of his bike, such that the rear wheel moves outwardly in one direction from the starting position and the motorcycle leans inwardly in the opposite direction, he can stabilize himself and the bike by gripping the handrail, which is at the appropriate height for such maneuver.

Additionally, the present portable display platform includes a means for transporting the platform. Preferably, such means for transporting the platform includes at least two tires 58. As is shown in the figures of the drawing, four tires are preferred in order to accommodate the relatively heavy rough surface floor section. Alternatively, other means of transporting the platform are also within the scope of the present invention. For example, the platform may be carried or loaded onto another vehicle for transporting.

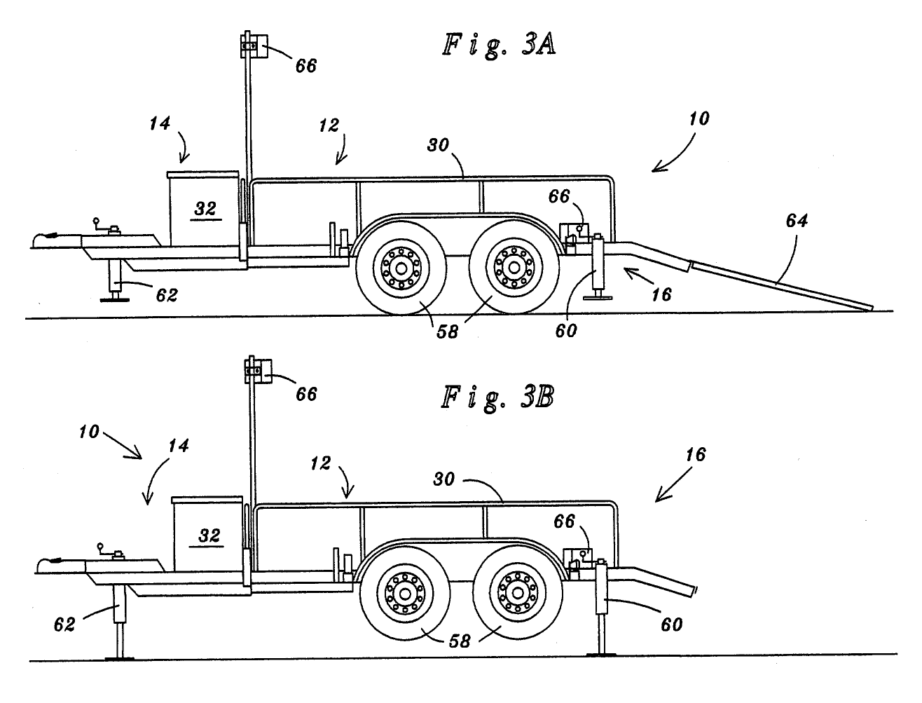

The present display platform also includes a means for stabilizing the platform during performance of the burnout stunt. Preferably, such means for stabilizing the platform during the performance of a stunt includes at least one jack 62. For additional support, rear jacks 60 are included in addition to the forward jack 62 which would typically be found on a trailer. The present platform also preferably includes a retractable ramp 64 as is shown in FIGS. 1, 2 and 3.

Furthermore, although safety is the primary focus of present invention, the primary function of the present portable display platform is entertainment. Thus, the body of the platform preferably includes ornamental indicia. While the choices of indicia are endless, preferred indicia include racing stripes, flames, lightening bolts, corporate logos, advertisements, and colors and designs associated with a particular venue. Optionally, such indicia may be provided on removable or replaceable panels.

It is also preferred that, in addition to the conventional functional lighting required of a towable trailer, the present display platform include ornamental lighting. For example, strobe lights 66 may be mounted above the level of the platform floor, to emphasize the smoke generated during the frictional engagement of the rear drive wheel. Similarly, lights, such as optical cables, which reflect downwardly onto the underlying street or parking surface may also be employed to increase the dramatic effect of the burnout stunt.

The foregoing description in the present invention has been presented for purposes of illustration and description. Furthermore, the description is not intended to limit the invention to the form disclosed herein. Consequently, variations and modifications commensurate with the above teachings, in the skill or knowledge of the relevant art are within the scope of the present invention. The embodiments described herein are further intended to explain the best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. A portable display platform for safely performing a motorcycle burnout stunt wherein the tire of the rear drive wheel is frictionally degraded, optionally to the point of bursting, the display platform comprising:
a platform body comprising a forward portion, a rear portion, and a platform floor surface;
a textured surface section defined within the platform floor surface, the textured surface section comprising a material having a roughness capable of frictionally degrading the rear drive wheel tire;
means for securing the front wheel tire of the motorcycle defined at the forward portion of the platform body, said means for securing the front wheel tire being capable of securing the motorcycle during the performance of the burnout stunt when the rear tire is frictionally degraded essentially to the point of bursting;
means for transporting the platform body; and
means for stabilizing the platform body during the performance of the burnout stunt;
wherein the display platform weighs less than about 10,000 pounds.

2. The portable display platform set forth in claim 1 wherein the platform weighs less than about 6,000 pounds.

3. The portable display platform set forth in claim 1 wherein the textured surface section of the platform floor surface comprises concrete.

4. The portable display platform set forth in claim 1 wherein the textured surface section of the platform floor surface comprises asphalt.

5. The portable display platform set forth in claim 1 further comprising handrails disposed about at least a portion of the platform body.

6. The portable display platform set forth in claim 1 further comprising ornament indicia.

7. The portable display platform set forth in claim 1 further comprising ornamental lighting.

8. The portable display platform set forth in claim 7 wherein said ornamental lighting comprises at least one strobe light disposed above the platform body.

9. The portable display platform set forth in claim 7 wherein said ornamental lighting comprises lighting disposed below the platform body.

10. The portable display platform set forth in claim 1 further comprising a retractable ramp at the rear portion of the platform body.
